(19) United States
(12) Patent Application Publication
(10) Pub. No.: US 2015/0370383 A1
(43) Pub. Date: Dec. 24, 2015

(54) ELECTRONIC APPARATUS AND SENSOR CONTROL METHOD

(71) Applicant: Kabushiki Kaisha Toshiba, Tokyo (JP)

(72) Inventors: Dai Oyama, Tachikawa Tokyo (JP); Toshiya Takano, Sagamihara Kanagawa (JP)

(21) Appl. No.: 14/496,576

(22) Filed: Sep. 25, 2014

Related U.S. Application Data
(60) Provisional application No. 62/015,972, filed on Jun. 23, 2014.

(51) Int. Cl. G06F 3/046

(52) U.S. Cl. CPC G06F 3/046; G06F 2203/04107

(57) ABSTRACT

According to one embodiment, an electronic apparatus includes a detector and a notification processor. The detector detects states of one or more components related to power supply to the electronic apparatus. The notification processor notifies a sensor of a frequency at which the sensor operates based on the states of the one or more components.

### CROSS-REFERENCE TO RELATED APPLICATIONS

This application claims the benefit of U.S. Provisional Application No. 62/015,972, filed Jun. 23, 2014, the entire contents of which are incorporated herein by reference.

### FIELD

Embodiments described herein relate generally to control of a device connected to an electronic apparatus.

### BACKGROUND

Recently, various electronic apparatuses such as tablets, PDAs and smartphones have been developed. Many of these electronic apparatuses include a touch screen display to facilitate operations by a user.

Sensors such as a touch panel and a digitizer provided in the touch screen display can be affected by the influence of electromagnetic noise (EM noise) produced by operations of the electronic apparatus. The precision of the sensors is decreased and the sensors malfunction under the influence of the noise. In order to avoid such influence of the noise, a shield to cut off the noise is provided in the electronic apparatus or components are operated so as not to exert influence on the sensors.

However, the size of the electronic apparatus is increased if a shield is provided. In addition, if the components are operated so as not to exert influence on the sensors, there is a possibility that functions of the components are limited.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic apparatus according to an embodiment.

FIG. 2 is a block diagram showing an exemplary system configuration of the electronic apparatus of the embodiment.

FIG. 3 is a block diagram showing an exemplary function configuration of a sensor management utility program executed by the electronic apparatus of the embodiment.

FIG. 4 is a diagram showing a configuration example of a state table used by the electronic apparatus of the embodiment.

FIG. 5 is a diagram showing a configuration example of a frequency determination table used by the electronic apparatus of the embodiment.

FIG. 6 is a diagram showing another configuration example of the frequency determination table used by the electronic apparatus of the embodiment.

FIG. 7 is an exemplary flowchart showing the procedure of sensor control processing executed by the electronic apparatus of the embodiment.

### DETAILED DESCRIPTION

Various embodiments will be described hereinafter with reference to the accompanying drawings.

In general, according to one embodiment, an electronic apparatus includes a detector and a notification processor. The detector detects states of one or more components related to power supply to the electronic apparatus. The notification processor notifies a sensor of a frequency at which the sensor operates based on the states of the one or more components.

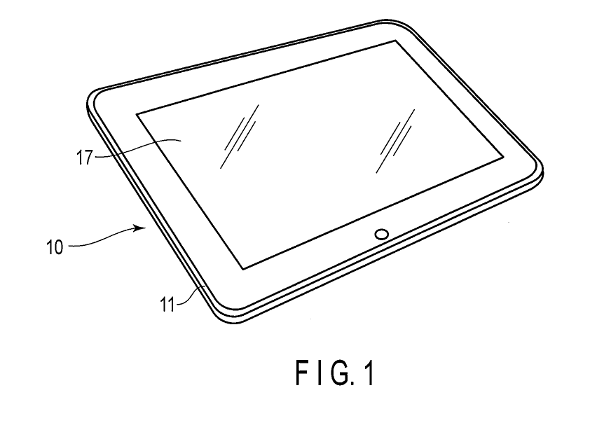

FIG. 1 is a perspective view showing an appearance of an electronic apparatus according to an embodiment. The electronic apparatus is, for example, a portable electronic apparatus capable of inputting data by a stylus or a finger. The electronic apparatus may be realized as a tablet computer, a notebook type personal computer, a smartphone, a PDA, etc. It is assumed hereinafter that the electronic apparatus is realized as a tablet computer 10 (hereinafter also referred to as a computer 10). The tablet computer 10 is a portable electronic apparatus which is also called a tablet or a slate computer and includes a body 11 and a touch screen display 17 as shown in FIG. 1. The touch screen display 17 is attached to the body 11 so as to overlap a top surface of the body 11.

The body 11 has a thin box-shaped housing. In the touch screen display 17, a flat-panel display and a sensor configured to detect a contact position and a contact pressure of a stylus or a finger on a screen of the flat-panel display are incorporated. The flat-panel display may be, for example, a liquid crystal display (LCD). As the sensor, for example, a capacitance type touch panel, an electromagnetic induction type digitizer, etc., may be used. It is assumed hereinafter that both two types of sensors, i.e., the digitizer and the touch panel, are incorporated into the touch screen display 17.

Each of the digitizer and the touch panel is provided to cover the screen of the flat-panel display. The touch screen display 17 can detect a touch operation to the screen using a stylus as well as a touch operation to the screen using a finger. The stylus may be an electromagnetic induction type stylus.

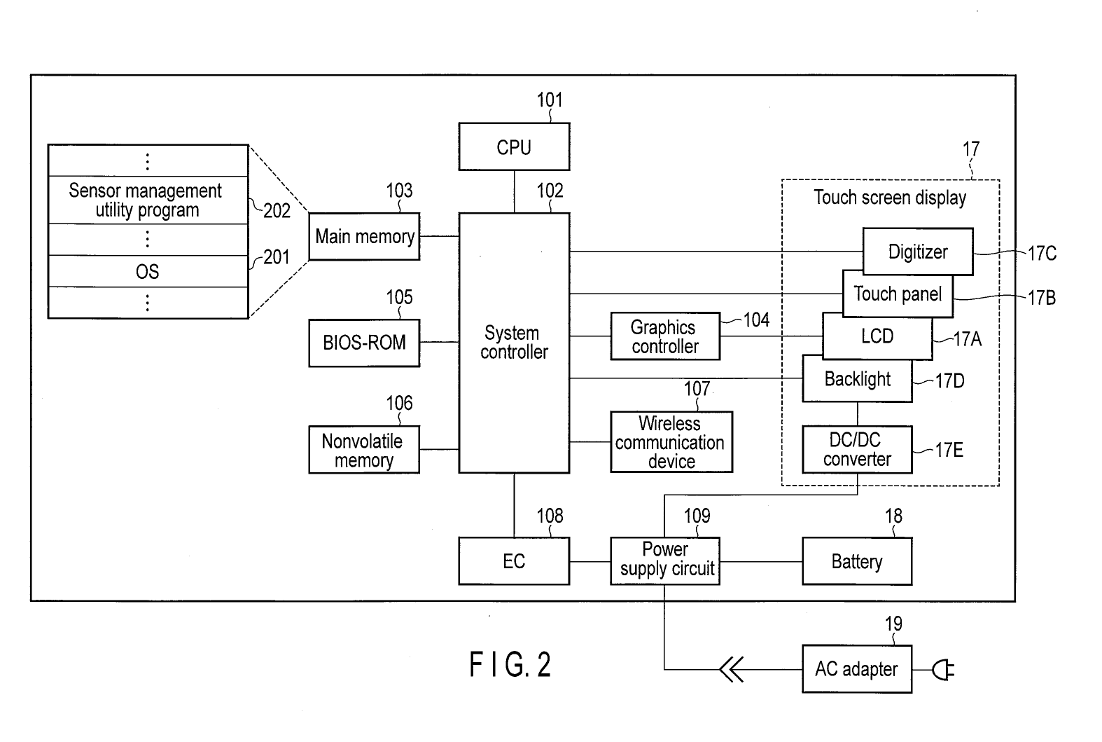

FIG. 2 is a diagram showing a system configuration of the tablet computer 10.

As shown in FIG. 2, the tablet computer 10 includes a CPU 101, a system controller 102, a main memory 103, a graphics controller 104, a BIOS-ROM 105, a nonvolatile memory 106, a wireless communication device 107, an embedded controller (EC) 108, a power supply circuit 109, etc.

The CPU 101 is a processor which controls operations of various components in the tablet computer 10. The CPU 101 executes various types of software loaded from the nonvolatile memory 106 serving as a storage device, into the main memory 103. The software includes an operating system (OS) 201 and various application programs. The application programs include a sensor management utility program 202. The sensor management utility program 202 has a function etc. of controlling a frequency (operating frequency) at which a sensor such as a touch panel 17B and a digitizer 17C is used in accordance with operating states of various components of the computer 10.

The CPU 101 also executes a basic input and output system (BIOS) stored in the BIOS-ROM 105. The BIOS is a program for hardware control.

The system controller 102 is a device which connects a local bus of the CPU 101 with various components. A memory controller which access-controls the main memory 103 is also built in the system controller 102. In addition, the system controller 102 has a function of executing communication with the graphics controller 104 via a serial bus conforming to the PCI EXPRESS standard, etc.

The graphics controller 104 is a display controller which controls an LCD 17A used as a display monitor of the tablet computer 10. A display signal generated by the graphics controller 104 is transmitted to the LCD 17A. The LCD 17A displays a screen image based on the display signal.

The touch panel 17B and the digitizer 17C are provided on the LCD 17A. The touch panel 17B is a capacitance type pointing device to execute input on the screen of the LCD 17A. A contact position, a movement, etc., on the screen touched by the finger are detected by the touch panel 17B. The digitizer 170 is an electromagnetic induction type pointing device to execute input on the screen of the LCD 17A. A position, a movement, a contact pressure, etc., on the screen where the stylus contacts are detected by the digitizer 17C.

The touch panel 17B and the digitizer 17C can output contact positions, movements, contact pressures, etc., on the screen to each component in the computer 10 via the system controller 102. The touch panel 17B and the digitizer 17C are controlled in accordance with a control signal (command) output via the system controller 102, and have, for example, a function of changing a frequency at which the touch panel 17B and the digitizer 17C operate based on the control signal.

In addition, a backlight 17D is arranged on the back surface of the LCD 17A. The backlight 17D, for example, emits light in accordance with the control signal output from the system controller 102 and controls light quantity (brightness) of the screen.

The wireless communication device 107 is a device configured to execute wireless communication such as wireless LAN or 3G mobile communication.

The EC 108 is a one-chip microcomputer including an embedded controller for power management. The EC 108 controls power supplied via the power supply circuit 109. The power is supplied from, for example, an external power source connected via an AC adapter 19 or a battery 18. The EC 108 can detect a power state indicating whether the power is supplied from the external power source, whether the power is supplied from the battery 18, etc., via the power supply circuit 109. The EC 108 also has a function of powering on or off the tablet computer 10 by controlling the power supply circuit 109 in accordance with a power button operation by a user.

The power supply circuit 109 controls supplying and stopping of the power to each component in the computer 10 in accordance with instructions from the EC 108. The power supply circuit 109 receives the power supply from the battery 18 or the external power source connected via the AC adapter 19, produces a voltage (for example, 5V) to be supplied to each component in the computer 10 and supplies operating power to each component.

The power supply circuit 109 turns on and off the power supply to, for example, a DC/DC converter 17E connected to the backlight 17D of the touch screen display 17 in accordance with instructions from the EC 108. When the power supply is on, the power supply circuit 109 supplies the power of a predetermined voltage (for example, the power of a voltage corresponding to the light quantity to be output from the backlight 17D) to the backlight 17D. The DC/DC converter 17E may be incorporated into the backlight 17D.

The DC/DC converter 17E produces a voltage to be supplied to the backlight 17D by using the voltage supplied from the power supply circuit 109, and supplies the power to the backlight 17D. The light quantity (brightness), etc., output from the backlight 17D can be thereby controlled. Similarly, the power supply circuit 109 can control power (voltage) supplied to each component (the CPU 101, the LCD 17A, the wireless communication device 107, etc.) in the computer 10.

A power supply microcomputer is provided in the power supply circuit 109. The power supply microcomputer monitors power supply (charging and discharging) to each component and the battery 18, a charging state (a remaining battery amount, a charging rate, etc.) of the battery 18, and presence or absence of connection to the AC adapter 19 (presence or absence of power supply from the outside).

The components in the computer 10 and the components connected to the computer 10 (the AC adapter 19, etc.) as described above may produce electromagnetic noise (EM noise) by their operation. A frequency (frequency band) of the produced noise is changed, for example, depending on operating states and use situations of one or more components related to the power supply to the computer 10. For example, the frequency of the produced noise is varied depending on the power (voltage) produced in the component or the power (voltage) supplied to the component. Such noise produced by the component may, for example, decrease the precision of various sensors used in the computer 10 or cause the sensors to malfunction.

Therefore, in the present embodiment, a frequency at which the sensor operates is determined so as not to overlap the frequency (frequency band) of the noise produced by the components of the computer 10 in order to avoid the decrease of precision or the malfunction of the sensor. The sensor can thereby be normally operated without limiting the functions of the components of the computer 10.

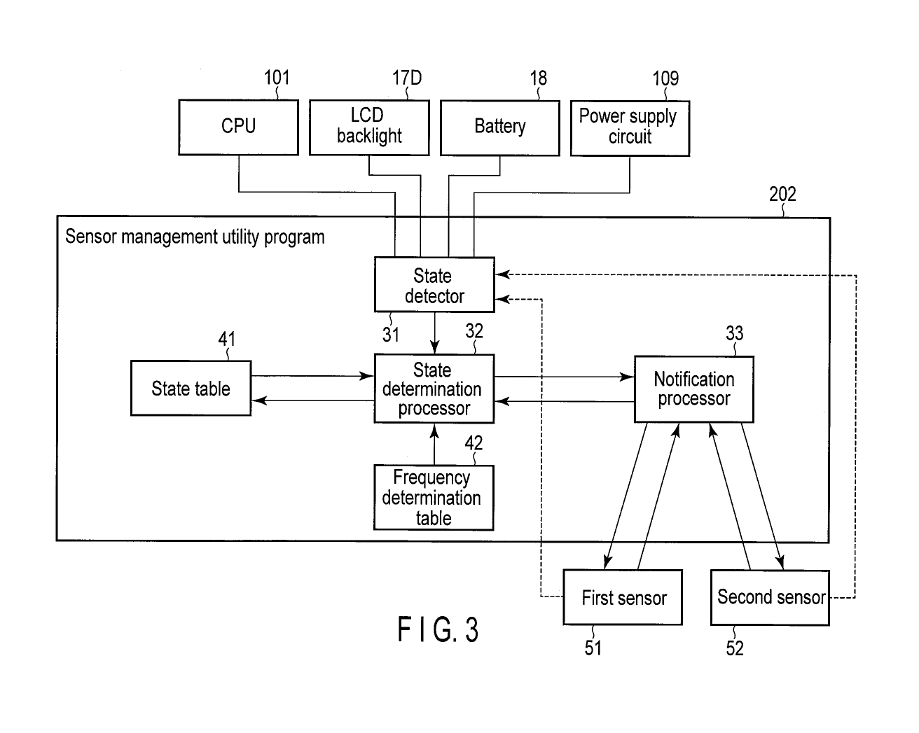

FIG. 3 shows a function configuration of the sensor management utility program 202 executed by the tablet computer 10. As described above, the sensor management utility program 202 controls a frequency (operating frequency) at which the sensor 51, 52 such as the touch panel 17B or the digitizer 17C is used in accordance with the operating states of various components of the computer 10. The sensor management utility program 202 includes, for example, a state detector 31, a state determination processor 32 and a notification processor 33.

The state detector 31 detects the operating states of components of the computer 10. These components are, for example, components related to the power supply to the computer 10, and built in or connected to the computer 10. The components related to the power supply include, for example, at least one of the battery 18, the power supply circuit 109 (AC adapter 19) and the backlight 17D (DC/DC converter 17E) of the display 17.

The state detector 31 detects the operating state related to power supply of each component. The state detector 31 may detect operating states that differ for each component.

More specifically, the state detector 31 detects a voltage (input voltage) of the power supplied to the LCD backlight 17D. The state detector 31 may detect the brightness of the LCD backlight 17D. The state detector 31 detects the charging rate of the battery 18. The state detector 31 detects which of the external power source and the battery 18 the computer 10 is driven, i.e., which of the external power supplied via the AC adapter 19 and the power supplied from the battery 18 the computer 10 is driven. The state detector 31 also detects the load of the CPU 101 (for example, usage rate of CPU).

It should be noted that the state detector 31 may constantly monitor the states of the components or periodically detect the states of the components. In addition, the state detector 31 may detect the states of the components in response to a request from the sensor 51, 52.

Next, the state determination processor 32 and the notification processor 33 notify the sensor 51, 52 of the frequency at which the sensor 51, 52 operates based on the detected operating states in accordance with changes in the operating states of the components. For example, the state determination processor 32 and the notification processor 33 notify the frequency at which the sensor 51, 52 operates based on the voltage of the power supplied to the LCD backlight 17D. The state determination processor 32 and the notification processor 33 notify the frequency at which the sensor 51, 52 operates based on the charging rate of the battery 18. The state determination processor 32 and the notification processor 33 notify the frequency at which the sensor 51, 52 operates based on which of the external power source and the battery 18 the computer 10 is driven. The state determination processor 32 and the notification processor 33 also notify the frequency at which the sensor 51, 52 operates based on the load of the CPU 101.

More specifically, the state determination processor 32 determines whether the currently detected operating states of the components have changed from the previously detected operating states of the components. The state determination processor 32 determines the change in the operating states by using a state table 41 in which the previously detected operating states of the components are stored.

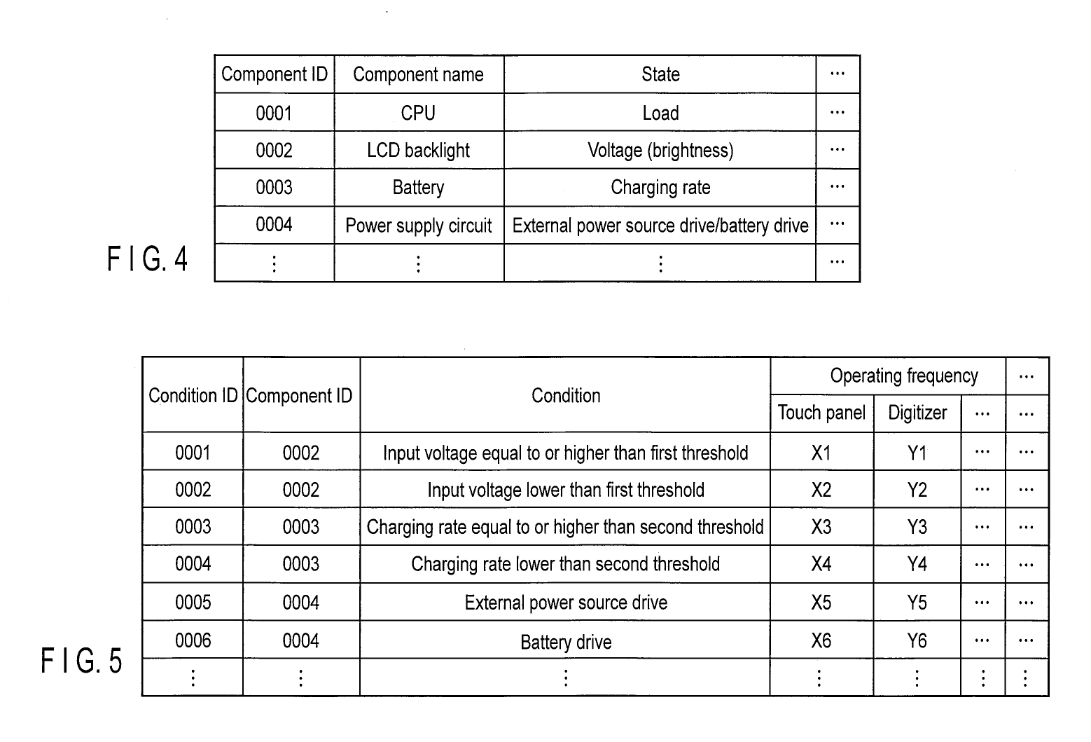

FIG. 4 shows a configuration example of the state table 41. The state table 41 includes a plurality of entries corresponding to a plurality of components. The components are internal or external components of the computer 10. Each entry includes, for example, a component ID, a component name and a state.

In an entry corresponding to a component, “component ID” indicates identification data added to the component. “Component name” indicates a name of the component. “State” indicates a state of the component. Various values such as a voltage (input voltage) of the power supplied to the LCD backlight 17D and a charging rate of the battery 18 are set to “state”.

When the currently detected operating states of the components are not changed from the previously detected operating states of the components, the operating frequency of the sensor 51, 52 is not changed.

In contrast, when the currently detected operating states of the components are changed from the previously detected operating states of the components, or when the operating states of the components are detected for the first time after the computer 10 is booted, the state determination processor 32 determines the operating frequency of the sensor 51, 52 by using the currently detected operating states of the components and a frequency determination table 42. The sensor 51, 52 is a pointing device which inputs an operation by the user by, for example, detecting contact of the finger or the stylus, and has a function of changing the frequency at which the sensor 51, 52 operates. The sensor 51, 52 includes, for example, at least one of the touch panel 17B, the digitizer 17C and a touch pad (not shown). The frequency determination table 42 is data indicative of correspondence between states of one or more components of the computer 10 and a frequency at which a sensor operates.

FIG. 5 shows a configuration example of the frequency determination table 42. The frequency determination table 42 includes a plurality of entries corresponding to a plurality of conditions for deciding the operating frequency of the sensor 51, 52. Each entry includes, for example, a condition ID, a component ID, a condition, and an operating frequency.

In an entry corresponding to a condition, “condition ID” indicates identification data added to the condition. “Component ID” indicates identification data added to a component which is a target of the condition. “Condition” indicates details of the condition. “Operating frequency” indicates operating frequency notified to the sensor 51, 52 when the condition is satisfied. A plurality of operating frequencies corresponding to a plurality of sensors 51 and 52 may be indicated in “operating frequency”.

The frequency determination table 42 is created based on, for example, a preliminarily examined tendency of noise produced by operations of each component of the computer 10.

More specifically, in the LCD backlight 17D having the component ID “0002”, for example, noise of low frequency tends to occur in the DC/DC converter, etc., for the power supply to the LCD backlight 17D when the input voltage is high (in other words, when the brightness of the LCD backlight 17D is high), and noise of high frequency tends to occur when the input voltage is low (i.e., when the brightness of the LCD backlight 17D is low).

Based on the above tendency, in an entry of condition ID “0001” in the frequency determination table 42, an operating frequency of the touch panel 17B is set to X1 [Hz] and an operating frequency of the digitizer 17C is set to Y1 [Hz] so as to avoid interference of the noise of low frequency which occurs when the input voltage of the LCD backlight 17D having the component ID “0002” is equal to or higher than a first threshold. Furthermore, in an entry of condition ID “0002” in the frequency determination table 42, the operating frequency of the touch panel 17B is set to X2 [Hz] and the operating frequency of the digitizer 17C is set to Y2 [Hz] so as to avoid interference of the noise of high frequency which occurs when the input voltage of the LCD backlight 17 having the component ID “0002” is lower than the first threshold. The operating frequency X1 [Hz] of the touch panel 17B when the input voltage is equal to or higher than the first threshold is, for example, higher than the operating frequency X2 [Hz] when the input voltage is lower than the first threshold. In addition, the operating frequency Y1 [Hz] of the digitizer 17C when the input voltage is equal to or higher than the first threshold is, for example, higher than the operating frequency Y2 [Hz] when the input voltage is lower than the first threshold.

In the battery 18 having the component ID “0003”, for example, the noise of low frequency tends to occur when the charging rate is high and the noise of high frequency tends to occur when the charging rate is low. It is assumed that the battery 18 is discharging and that an input voltage of power supplied by the battery 18 having a high charging rate is higher than an input voltage of power supplied by the battery 18 having a low charging rate.

Based on the above tendency, in an entry of condition ID “0003” in the frequency determination table 42, the operating frequency of the touch panel 17B is set to X3 [Hz] and the operating frequency of the digitizer 17C is set to Y3 [Hz] so as to avoid the interference of the noise of low frequency which occurs when the charging rate of the battery 18 having the component ID “0003” is equal to or higher than a second threshold. In an entry of condition ID “0004” in the frequency determination table 42, the operating frequency of the touch panel 17B is set to X4 [Hz] and the operating frequency of the digitizer 17C is set to Y4 [Hz] so as to avoid the interference of the noise of high frequency which occurs when the charging rate of the battery 18 having the component ID “0003” is lower than the second threshold. The operating frequency X3 [Hz] of the touch panel 17B when the charging rate is equal to or higher than the second threshold is, for example, higher than the operating frequency X4 [Hz] when the charging rate is lower than the second threshold. The operating frequency Y3 [Hz] of the digitizer 17C when the charging rate is equal to or higher than the second threshold is, for example, higher than the operating frequency Y4 [Hz] when the charging rate is lower than the second threshold.

In the power supply circuit 109 having the component ID “0004”, for example, the noise of low frequency tends to occur when the computer 10 is driven by the external power source and the noise of high frequency tends to occur when the computer 10 is driven by the battery 18. It is assumed that an input voltage of the power supplied by the external power source is higher than an input voltage of the power supplied by the battery 18. In addition, noise produced in the AC adapter 19 may propagate in the computer 10 via an electric power line when the computer 10 is driven by the external power source. The strength of the noise may be increased when the charging rate of the battery 18 is equal to or lower than a predetermined threshold.

Based on the above tendency, in an entry of condition ID “0005” in the frequency determination table 42, the operating frequency of the touch panel 17B is set to X5 [Hz] and the operating frequency of the digitizer 17C is set to Y5 [Hz] so as to avoid the interference of the noise of low frequency which occurs when the computer 10 is driven by the external power source via the power supply circuit 109 having the component ID “0004”. In an entry of condition ID “0006” in the frequency determination table 42, the operating frequency of the touch panel 17B is set to X6 [Hz] and the operating frequency of the digitizer 17C is set to Y6 [Hz] so as to avoid the interference of the noise of high frequency which occurs when the computer 10 is driven by the battery 18 via the power supply circuit 109 having the component ID “0004”. The operating frequency X5 [Hz] of the touch panel 17B in the case of driving by the external power source is, for example, higher than the operating frequency X6 [Hz] in the case of driving by the battery. The operating frequency Y5 [Hz] of the digitizer 17C in the case of driving by the external power source is, for example, higher than the operating frequency Y6 [Hz] in the case of driving by the battery. As described above, since the noise may be strengthened on the condition that the computer 10 is driven by the external power source and the battery capacity is lower than a predetermined threshold, the operation frequencies of the touch panel 17B and the digitizer 17C may be changed so as to avoid the noise when the above condition is satisfied.

The state determination processor 32 determines the operating frequency of the sensor 51, 52 corresponding to the states detected from the components by using the frequency determination table 42 and outputs the determined operating frequency to the notification processor 33. The frequency determination table 42 is prepared based on the characteristics of the noise of the components. Therefore, the state determination processor 32 can determine the operating frequency of the sensor 51, 52 easily (with a small amount of processing) by merely referring to the frequency determination table 42.

The notification processor 33 notifies each sensor 51, 52 of the determined operating frequency of the sensor 51, 52. The notification processor 33 notifies the sensor 51, 52 of the operating frequency by using, for example, a USB command. The notification processor 33 may output a high or low signal to the sensor 51, 52 via a GPIO (general purpose input/output) interface and thereby request the sensor 51, 52 to operate at the operation frequency associated with the respective signals.

The sensor 51, 52 receives the notification of the operating frequency from the notification processor 33 and changes the operating frequency. The sensor 51, 52 notifies the notification processor 33 that the change of the operating frequency is completed.

Then, the state determination processor 32 updates the state table 41 by using the currently detected state of each component in response to the receipt of the notification from the sensor 51, 52 by the notification processor 33 that the change of the operating frequency is completed. Whether the states of the components detected for the next time are changed is determined by using the updated state table 41.

The above configuration enables the computer 10 to operate the sensor 51, 52 normally without limiting functions of the components. Since the sensor management utility program 202 can change the operation frequency of the sensor 51, 52 before the sensor 51, 52 is used in accordance with, for example, use situations of the components, the sensor 51, 52 can be operated without being affected by the influence of the noise caused by operations of the components and degrading the performance of the components.

In the frequency determination table 42 shown in FIG. 5, the operation frequency of the sensor 51, 52 is determined based on the state of one component. However, the operation frequency of the sensor 51, 52 may be determined based on states of a plurality of components.

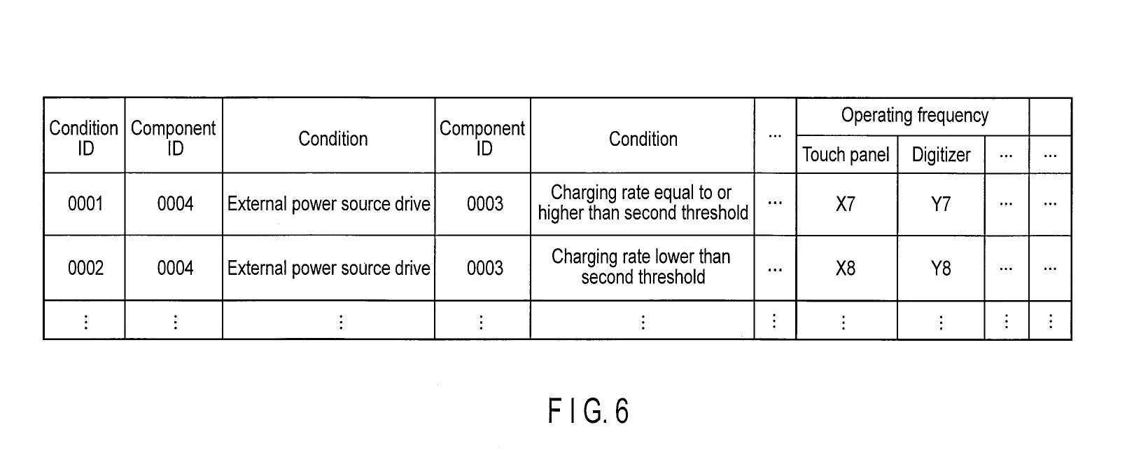

FIG. 6 shows a configuration example of the frequency determination table 42 in which the operation frequency of the sensor 51, 52 is determined based on states of a plurality of components. The frequency determination table 42 includes a plurality of entries corresponding to a plurality of combinations of conditions for determining the operating frequency of the sensor 51, 52. Each entry includes, for example, a condition ID, a plurality of component IDs and a plurality of conditions, and operation frequency.

In an entry corresponding to a combination of conditions, “condition ID” indicates identification data added to the combined conditions. “Component ID” indicates identification data added to a component which is a target of one condition of the combined conditions. “Condition” indicates details of one condition of the combined conditions. That is, one condition of the combined conditions is defined by a pair of “component ID” and “condition” in this entry. “Operating frequency” indicates operating frequency notified to the sensor 51, 52 when the combined conditions indicated by a plurality of pairs of “component ID” and “condition” are satisfied.

As described above, the frequency determination table 42 is created based on, for example, the preliminarily examined tendency of noise produced by operations of each component of the computer 10.

More specifically, in the power supply circuit 109 having the component ID “0004”, for example, the noise of low frequency tends to occur when the computer 10 is driven by the external power source and the noise of high frequency tends to occur when the computer 10 is driven by the battery 18. In addition, when the computer 10 is driven by the external power source, it is assumed that the battery 18 having the component ID “0003” is charged. In the battery 18 which is being charged, for example, the noise of high frequency tends to occur when the charging rate is high and the noise of low frequency tends to occur when the charging rate is low.

Based on the above tendency, in an entry of condition ID “0001” in the frequency determination table 42, when the computer 10 is driven by the external power source via the power supply circuit 109 having the component ID “0004”, and the charging rate of the battery 18 having the component ID “0003” is equal to or higher than the second threshold, the operating frequency of the touch panel 17B is set to X7 [Hz] and the operating frequency of the digitizer 17C is set to Y7 [Hz] so as to avoid the interference of both the noise of low frequency produced by driving by the external power source and the noise of high frequency produced by driving by the battery 18 which is being charged. In an entry of condition ID “0002” in the frequency determination table 42, when the computer 10 is driven by the external power source via the power supply circuit 109 having the component ID “0004”, and the charging rate of the battery 18 having the component ID “0003” is lower than the second threshold, the operating frequency of the touch panel 17B is set to X8 [Hz] and the operating frequency of the digitizer 17C is set to Y8 [Hz] so as to avoid the interference of both the noise of low frequency produced by driving by the external power source and the noise of low frequency produced by the battery 18 which is being charged.

The state determination processor 32 determines the operation frequency of the sensor 51, 52 corresponding to the states detected from a plurality of components by using the above-described frequency determination table 42 and outputs the determined operation frequency to the notification processor 33. Then, the notification processor 33 notifies each sensor 51, 52 of the determined operating frequency of the sensor 51, 52.

Since the operation frequency is changed in the sensor 51, 52 in response to the notification of the operation frequency by the notification processor 33, the sensor 51, 52 can be normally operated in consideration of the noise produced by a plurality of components of the computer 10.

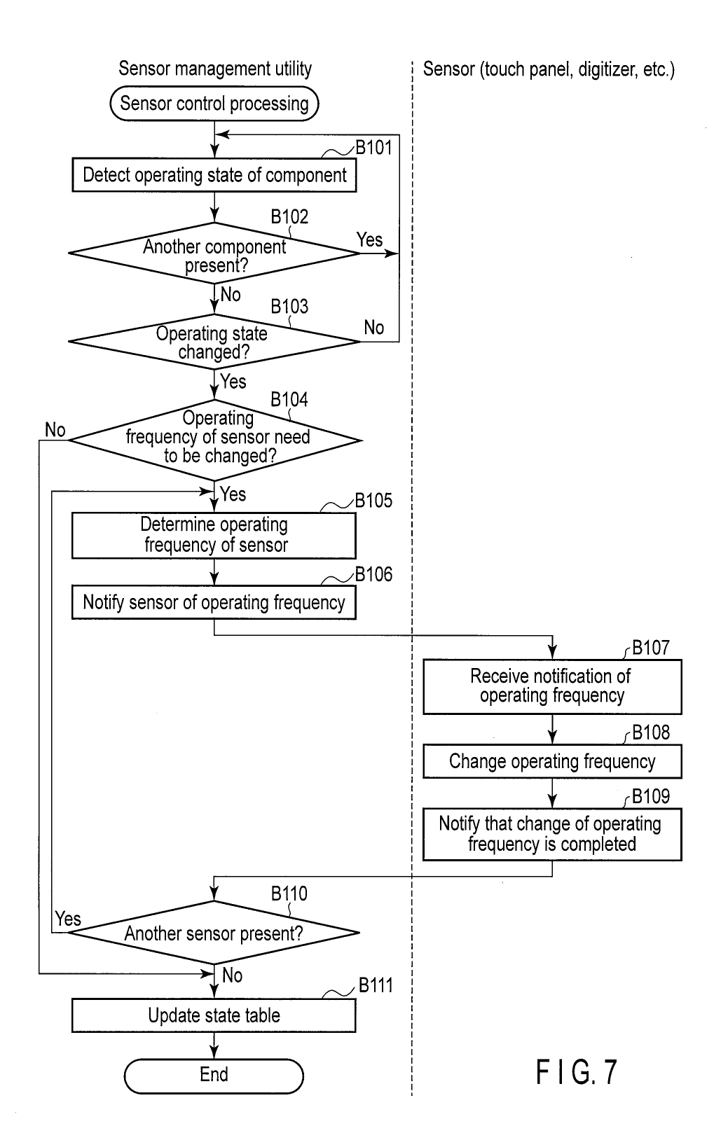

Next, with reference to a flowchart in FIG. 7, an example of the procedure of sensor control processing executed by the sensor management utility program 202 will be described.

First, the state detector 31 of the sensor management utility program 202 detects an operating state of a component of the computer 10 (block B101). This component is related to, for example, power supply to the computer 10, and built in or connected to the computer 10. The state detector 31 may detect operating states whose types differ for each component. For example, the state detector 31 detects the charging rate from the battery 18 and detects from the power supply circuit 109 which of the power supplied via the AC adapter 19 and the power supplied from the battery 18 the computer 10 is driven.

The state detector 31 determines whether another component whose operating state should be detected is present (block B102). If another component is present (Yes in block B102), the processing returns to block B101 and the operating state of the component is detected.

In contrast, if another component is not present (No in block B102), i.e., if the operating states of all the components which are the target of detection are detected, the state determination processor 32 determines whether the operating states of the components have been changed (block B103). The state determination processor 32 determines whether the operating states of the components have been changed by comparing the last operating states of the components indicated in the state table 41 with the detected operating states. If the operating states of the components have not been changed (No in block B103), the processing returns to block B101 and the operating states of the components are further detected.

If the operating states of the components have been changed (Yes in block B103), the state determination processor 32 determines whether the operating frequency of the sensor 51, 52 needs to be changed by using the detected operating states of the components and the frequency determination table 42 (block B104). If the operating frequency of the sensor 51, 52 needs to be changed (Yes in block B104), the state determination processor 32 determines the operating frequency of the sensor 51, 52 by using the detected operating states of the components and the frequency determination table 42 (block B105). Then, the notification processor 33 notifies the sensor 51, 52 of the determined operating frequency (block B106).

The sensor 51, 52 receives the notification of the operating frequency by the notification processor 33 (block B107) and changes the operating frequency (block B108). Then, the sensor 51, 52 notifies the notification processor 33 that the change of the operating frequency is completed (block B109).

In response to the receipt of the completion notification of the change of the operating frequency from the sensor 51, 52 by the notification processor 33, the state determination processor 32 determines whether another sensor whose operation frequency should be changed is present (block B110). If another sensor whose operation frequency should be changed is present (Yes in block B110), the processing returns to block B105 and the processing to change the operating frequency of the sensor is executed.

If another sensor whose operating frequency should be changed is not present (No in block B110), i.e., if the change of the operating frequencies of all the sensors is completed, the state determination processor 32 updates the state table 41 by using the operating states of the components detected by the state detector 31 (block B111). Even if the operating frequency of the sensor needs not to be changed (No in block B104), the state determination processor 32 updates the state table 41 by using the operating states of the components detected by the state detector 31 (block B111).

As described above, the present embodiment enables a sensor to be normally operated without limiting functions of components of an electronic apparatus.

The state detector 31 detects states of one or more components related to the power supply to the computer 10. The notification processor 33 notifies the sensor 51, 52 of a frequency at which the sensor 51, 52 operates based on the states of the one or more components. The operating frequency is thereby notified to the sensor 51, 52 in accordance with the states of the components in the present embodiment. Therefore, the sensor can be normally operated without limiting functions of the components.

Since each type of the processing of the present embodiment can be realized by a computer program, the same advantage as the present embodiment can be easily achieved by merely installing the computer program on a general computer through a computer-readable storage medium which stores the computer program and executing the computer program.

The various modules of the systems described herein can be implemented as software applications, hardware and/or software modules, or components one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a detector to detect states of one or more components related to power supply to the electronic apparatus; and
a notification processor to notify a sensor of a frequency at which the sensor operates based on the states of the one or more components.

2. The electronic apparatus of claim 1, wherein the one or more components comprise at least one of a battery, a power supply circuit and a backlight of a display.

3. The electronic apparatus of claim 1, wherein the sensor comprises at least one of a touch panel, a digitizer and a touch pad.

4. The electronic apparatus of claim 1, further comprising a body, and
a touch screen display which overlaps a top surface of the body and comprises a display, a backlight and at least one of a touch panel and a digitizer,
wherein the sensor comprises at least one of the touch panel and the digitizer.

5. The electronic apparatus of claim 1, wherein the notification processor notifies the frequency at which the sensor operates by using data indicative of correspondence between the states of the one or more components and the frequency at which the sensor operates.

6. The electronic apparatus of claim 1, wherein the notification processor notifies the frequency at which the sensor operates in accordance with a change of the states of the one or more components.

7. The electronic apparatus of claim 1, wherein the detector detects which of an external power source and a battery the electronic apparatus is driven, and
the notification processor notifies the frequency at which the sensor operates based on which of the external power source and the battery the electronic apparatus is driven.

8. The electronic apparatus of claim 1, wherein the detector detects a voltage of power supplied to a backlight of a display, and
the notification processor notifies the frequency at which the sensor operates based on the voltage.

9. The electronic apparatus of claim 1, wherein the detector detects a charging rate of a battery, and
the notification processor notifies the frequency at which the sensor operates based on the charging rate.

10. A sensor controlling method comprising:
detecting states of one or more components related to power supply to an electronic apparatus; and
notifying a sensor of a frequency at which the sensor operates based on the states of the one or more components.
